(19) United States
(12) Patent Application Publication
(10) Pub. No.: US 2007/0139430 A1
(43) Pub. Date: Jun. 21, 2007

(54) Rendering "gadgets" with a browser

(75) Inventors: David S. Korn, Sunnyvale, CA (US); Jay C. Jacobs, Danville, CA (US); Neel L. Murarka, San Francisco, CA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/314,485

(22) Filed: Dec. 21, 2005

(51) Int. Cl. G06F 9/00; G06F 3/00

(52) U.S. Cl. 345/581; 715/768; 715/764; 715/810

(57) ABSTRACT

The claimed subject matter provides a system and/or a method that facilitates generating and displaying a graphical item. An interface component can facilitate receipt of data related to the graphical item associated with an operating system. An enhancement component can leverage a browser to generate the graphical item with an opaque portion and at least one of a translucent portion and a transparent portion.

### BACKGROUND

Technological advances in computer hardware, software and networking have lead to efficient, cost effective computing systems (e.g., desktop computers, laptops, handhelds, cell phones, servers . . . ) that can communicate with each other from essentially anywhere in the world in order to exchange information. These systems continue to evolve into more reliable, robust and user-friendly systems. As a consequence, more and more industries and consumers are purchasing computers and utilizing them as viable electronic alternatives to traditional paper and verbal media for exchanging information. For example, many industries and consumers are leveraging computing technology to improve efficiency and decrease cost through web-based (e.g., on-line) services. For instance, consumers can search and retrieve particular information (e.g., via a search engine), purchase goods, view bank statements, invoke monetary transactions (e.g., pay a bill on-line), research products and companies, apply for employment, obtain real-time stock quotes, obtain a college degree, obtain news, access entertainment (e.g., video, music, programming), download files and applications, transmit correspondence (e.g., email, chat rooms . . . ), etc. with the click of a mouse.

User Interfaces (UIs) are commonly employed in connection with microprocessor-based devices to enhance a user's ability to view information (e.g., text, options, controls, etc.) and to provide the user with a mechanism to interact (e.g., invoke functionality) with a device wherein the underlying UI code is executing. By way of example, many personal computers today employ operating systems that deploy a UI when booting-up. Depending on system configuration, this UI can provide system configuration information such as power management settings, boot sequence, hardware configuration options, control of a system clock, manual mode selection, etc. In other instances, the UI can provide a framework in which applications can be executed. Commonly, invocation of an application elicits the creation of anther UI(s) (e.g., a UI that executes within or over the main UI).

For example, a word processor application can be launched from within a UI (e.g., via an icon or menu item), wherein a word processing UI is deployed. The user can utilize this UI to create documents (e.g., via voice recognition features, a mouse and a keyboard), format text and paragraphs therein, email the document to others, save the document to memory, etc. In many instances, even environments that traditionally leverage command line activity utilize a general UI as a framework wherein the command UI can be created to provide a user with command line functionality within a command UI. The foregoing represents an evolution in paradigms (from command line to UI-based applications) in the programming domain.

The popularity of UI's correlate with the popularity of computer systems, hardware, and software, such that both have become extremely successfully in the commercial and functional realm. UI's can provide an infinite amount of data to a user via a display, to enhance the user's experience with the computer system, hardware, and/or software. Yet, the increase of implementing UI's is not solely contributed to the content on which is displayed, but also the presentation and/or appearance of such UI's. Conventional UI's are restricted in a rectangular shape and having solely opaque portions. Conventional UI's have continuously grown in popularity; therefore, such restraints are extremely obsolete.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate displaying a graphical item having at least one of a transparent and translucent portion by leveraging a browser engine. An enhancement component can display a graphical item by leveraging a browser component, wherein the graphical item displayed includes at least one of a transparent portion and a translucent portion. The enhancement component can receive data associated with the graphical item via an interface component. The data received can be, but is not limited to being, an image, a text, applets, applications, small task items, a picture, a graphic, a pixel, and/or any data to be displayed and/or presented. Furthermore, the graphical item can be associated with an applet, image, application, small task items, and/or program, wherein such can be referred to as a “gadget.” The graphical item can be associated with a rich content applet with non-standard rectangular user interfaces (e.g., non-rectangular windows displayed utilizing areas of transparency and/or translucency).

In accordance with one aspect of the claimed subject matter, the enhancement component can utilize an analyzer that can dynamically partition the graphical item into a first portion and a second portion to allow display of translucent and/or transparent portions associated therewith. The analyzer can partition the graphical item such that the first portion is a foreground image that can be hosted by a browser control. Moreover the analyzer can partition the graphical item such that the second portion is an image for a background visual area (e.g., background window).

In accordance with another aspect of the claimed subject matter, the enhancement can include a generator that can create the foreground image and the background visual area based at least in part upon the analyzer. The generator can create the foreground image by setting a non-opaque pixel to opaque with a particular color. In addition, the generator can create the image for the background visual area (e.g., background window) by setting a pixel with an alpha value related to opaque to an alpha value related to transparent. Furthermore, the enhancement component can utilize a map component that can provide post-processing (e.g., mapping pixels with the particular color to transparent) on the first portion (e.g., the foreground image hosted by the browser control). In other aspects of the claimed subject matter, methods are provided that facilitate displaying a graphical item including two portions utilizing a browser rendering engine.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates displaying a graphical item having at least one of a transparent and translucent portion by leveraging a browser engine.

FIG. 2 illustrates a block diagram of an exemplary system that facilitates presenting a graphical item including two portions utilizing a browser rendering engine.

FIG. 3 illustrates a block diagram of an exemplary system that facilitates employing a graphical item referred to as a gadget that has a transparent and/or translucent portion by leveraging a rendering engine related to a browser.

FIG. 4 illustrates a series of portions related to a graphical item rendered by leveraging a browser.

FIG. 5 illustrates a block diagram of an exemplary system that facilitates employing a graphical item by leveraging a browser associated with an operating system to provide translucent and/or transparent portion of the graphical item.

FIG. 6 illustrates a block diagram of an exemplary system that facilitates displaying a graphical item having at least one of a transparent and translucent portion by leveraging a browser engine.

FIG. 7 illustrates an exemplary methodology for presenting a graphical item including two portions utilizing a browser rendering engine.

FIG. 8 illustrates an exemplary methodology that facilitates employing a graphical item referred to as a gadget that has a transparent and/or translucent portion by leveraging a rendering engine related to a browser.

FIG. 9 illustrates an exemplary methodology that facilitates displaying a graphical item having at least one of a transparent and translucent portion by leveraging a browser engine.

FIG. 10 illustrates an exemplary networking environment, wherein the novel aspects of the claimed subject matter can be employed.

FIG. 11 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “analyzer,” “generator,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD). . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

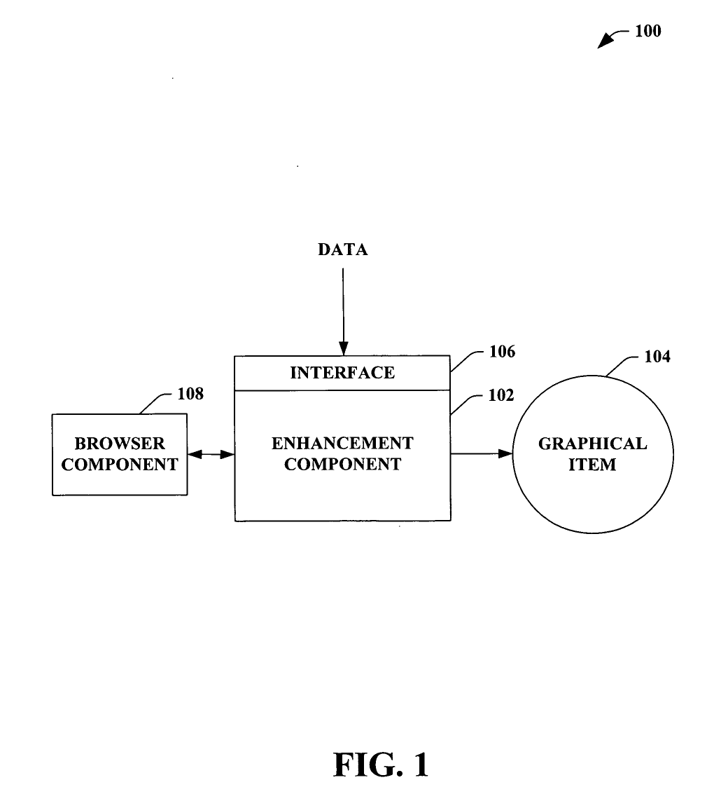

Now turning to the figures, FIG. 1 illustrates a system 100 that facilitates displaying a graphical item having at least one of a transparent and translucent portion by leveraging a browser engine. The system 100 can include an enhancement component 102 that leverages a browser component 108 to provide the display of a graphical item 104, wherein the graphical item 104 includes at least one of a translucent portion and a transparent portion therewith. The enhancement component 102 can receive data associated with the graphical item 104 via an interface component 106. The data received can be, but is not limited to being, an image, a text, applets, applications, small task items, a picture, a graphic, a pixel, and/or any data to be displayed and/or presented. By utilizing the enhancement component 102, the graphical item 104 can be displayed and/or presented such that the graphical item can include a translucent portion and a transparent portion.

It is to be appreciated and understood that the graphical item 104 with at least one of a translucent portion and a transparent portion can be associated with an applet, image, application, small task items, and/or program, wherein such can be referred to as a “gadget.” In other words, the graphical item 104 can be any suitable data to be displayed, wherein such data includes a transparent portion and/or a translucent portion. The graphical item 104 can be associated with a rich content applet with non-standard rectangular user interfaces (e.g., non-rectangular windows displayed utilizing areas of transparency and/or translucency). For instance, by utilizing the enhancement component 102, the graphical item 104 can include a transparent portion such that the graphical item 104 can be non-rectangular. Moreover, the enhancement component 102 can implement the graphical item 104 to include a translucent portion such that the graphical item 104 can include, for example, a shadow. Thus, the graphical item 104 can be displayed and/or presented with non-rectangular and/or translucent portions in any graphical user interface operating system and/or environment by leveraging the browser component 108.

The enhancement component 102 can leverage the browser component 108 to facilitate displaying the graphical item 104 to allow for the graphical item 104 to include a translucent portion and/or a transparent portion. It is to be appreciated that the browser component 108 can be any suitable browser associated with an operating system and/or graphical user interface operating system. In other words, the enhancement component 102 can utilize any suitable browser to provide rendering for the graphical item 104. For instance, the browser component 108 can include a browser engine that provide the graphical item 104, yet not utilize the web browser application associated with the browser. The enhancement component 102 can enhance and/or manipulate the browser component 108 to display the graphical item 104 with non-rectangular portions and/or non-opaque portions. In a particular example, the browser component 108 can include object linking and embedding (OLE) control extension (OCX) control that can be specifically leveraged by the enhancement component 102.

For example, the enhancement component 102 can utilize the browser component 108 to display a graphical item 104 to a display (not shown) such as, but not limited to, a computer screen, a monitor, an liquid crystal display (LCD), a monitor, a flat-panel, a computer monitor, a television, a plasma screen, a touch-screen, and a portable digital assistant (PDA), etc. Conventionally, the graphical item 104 having at least one of a transparent portion and a translucent portion can not be displayed. Yet, utilizing the enhancement component 102, the graphical item 104 can be presented with the translucent and/or transparent portion on the display by leveraging the rendering engine associated with the browser component 108.

Take, for example, a graphical item that is associated with a stock ticker applet which dynamically displays stock quotes. Typically, a portion to be displayed that relates to the stock ticker applet can be constricted by a rectangular visual area with solely opaque portions. The stock ticker applet can occlude, conceal, and/or obstruct a wallpaper and/or background associated with a typical operating system and minimize the amount of data presented on the display. By implementing the system 100, the stock ticker applet can be displayed with translucent and/or transparent portions such that the applet is not restricted to have a rectangular visual area and solely opaque portions (e.g., a border, a caption, a chrome, etc.). In other words, the enhancement component 102 can provide rendering of the at least one graphical item 104 with a translucent and/or transparent portion to a user via the display. With the system 100, the stock ticker applet can be displayed with, for instance, drop shadows, translucent portions, non-rectangular shaped visual area to display stock data, etc.

Moreover, the system 100 can include any suitable and/or necessary interface component 106, which provides various adapters, connectors, channels, communication paths, etc. to integrate the enhancement component 102 into virtually any operating and/or database system(s). In addition, the interface component 106 can provide various adapters, connectors, channels, communication paths, etc., that provide for interaction with the enhancement component 102, the graphical item 104, the browser component 108, and/or any data related to the system 100.

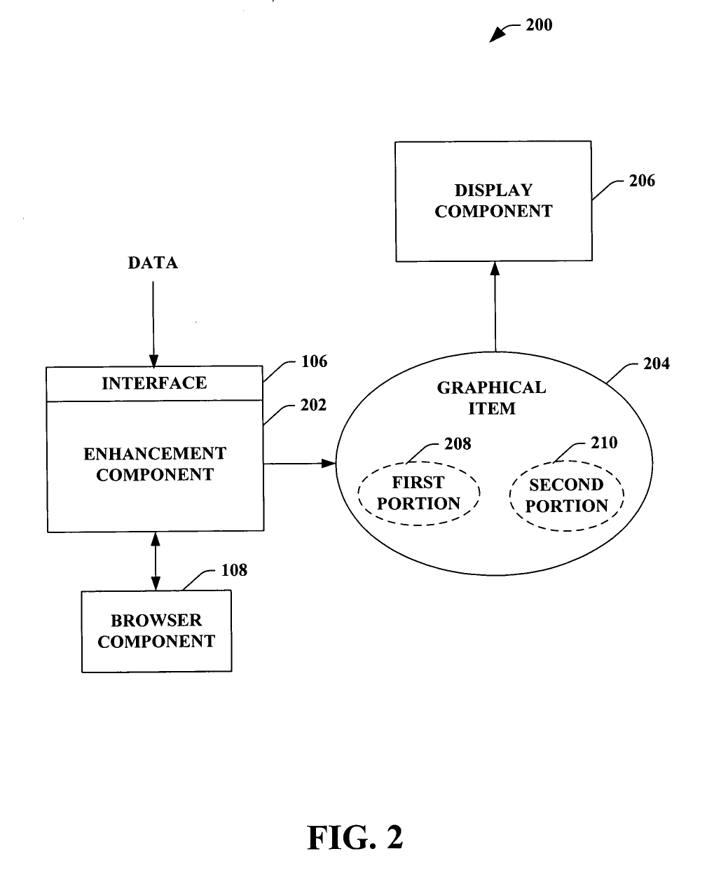

FIG. 2 illustrates a system 200 that facilitates presenting a graphical item including two portions utilizing a browser rendering engine. The system 200 can include an enhancement component 202 that provides seamless display of a graphical item 204 that includes at least one of a transparent portion and a translucent portion. The enhancement component 202 can receive data related to the graphical item 204 via the interface 106, wherein the enhancement component 202 can leverage the browser component 108 to render such graphical item 204 to a user. It is to be appreciated that the browser component can include any suitable browser engine that provides rendering of data. By employing the enhancement component 202, the graphical item 204 can include transparent and/or translucent portions and can be displayed and/or output to a user via a display component 206. The display component 206 can be, but is not limited to, a computer screen, a monitor, an liquid crystal display (LCD), a monitor, a flat-panel, a computer monitor, a television, a plasma screen, a touch-screen, and a portable digital assistant (PDA), and/or any suitable device utilized to display data to a user.

It is to be appreciated that the graphical item 204 can be associated with any suitable applet, image, application, small task items, and/or program, wherein such applet, image, application, small task item, and/or program can be referred to as a “gadget.” For example, the graphical item 204 can include a transparent and/or translucent portion and can be, but is not limited to being, a stock ticker, a weather forecast, an icon, an information providing applet, a traffic feed, a system utility, a camera viewer, a calendar, a clock, a game, a search tool, an application enhancer, a media player, a volume control, an audio clip player, a sound byte player, a monitor adjuster, etc. The enhancement component 202 provides the display of at least the graphical item 204 that includes areas of translucency, transparency, and/or any combination thereof.

The enhancement component 202 can dynamically separate data related to the graphical item 204 into a first portion 208 and a second portion 210 to allow the display of any transparent and/or translucent portions related to the graphical item 204. The enhancement component 202 can implement dynamic separation (discussed infra) for the first portion 208 and the second portion 210, wherein the first portion 208 can include opaque and transparent areas and/or pixels and the second portion 210 can include translucent and transparent areas and/or pixels. The enhancement component 202 provides an accurate display of the first portion 208 and the second portion 210 associated with the graphical item 204 having transparent and/or translucent portions. The enhancement component 202 does this by leveraging the rendering engine associated with the browser component 108 to display the first portion 208, while the enhancement component 202 itself displays the second portion 210. In other words, the graphical item 204 can be displayed by utilizing the dynamically split (e.g., separated) portions (e.g., first portion 208 and second portion 210) with the browser rendering engine associated with the browser component 108 and the enhancement component 202.

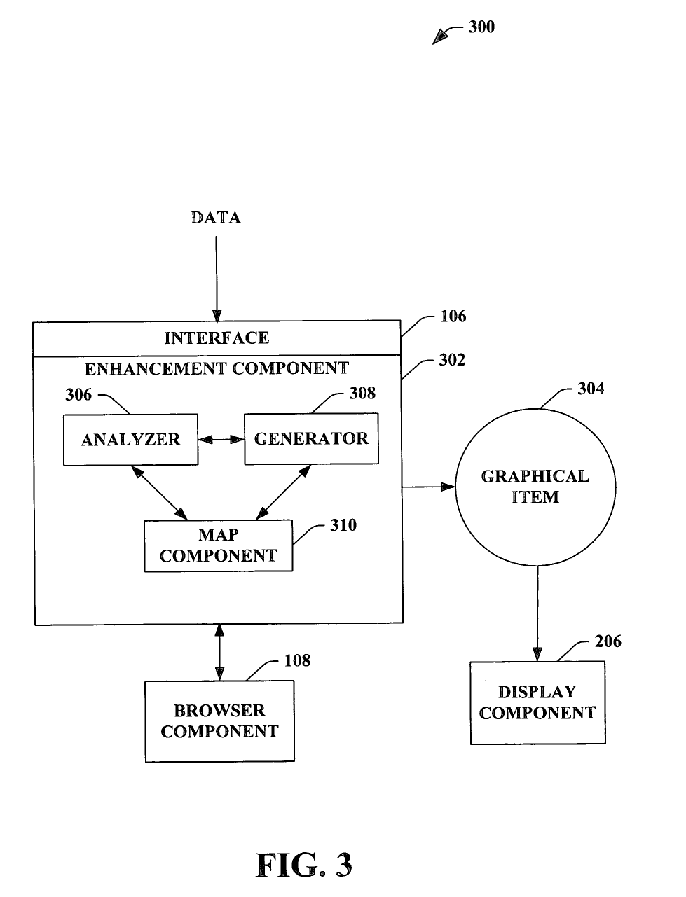

FIG. 3 illustrates a system 300 that facilitates employing a graphical item referred to as a gadget that has a transparent and/or translucent portion by leveraging a rendering engine related to a browser. The system 300 can include an enhancement component 302 that facilitates displaying a graphical item 304 that has a transparent portion, a translucent portion, and/or any combination thereof. The enhancement component 302 can leverage a browser component 108, and in particular, a browser rendering engine, to present the graphical item 304 to a display (not shown). The enhancement component 302 can employ the rendering engine associated with the browser component 108 to provide the display of the graphical item 304 having at least one of a transparent and/or translucent portion to the display component 206 within any graphical user interface operating system environment.

The enhancement component 302 can receive data related to the graphical item 304 including the transparent and/or translucent portion via the interface 106. For example, the data can be any suitable applet, image, application, small task items, and/or program, wherein such applet, image, application, small task item, and/or program can be referred to as a “gadget.” For example, the graphical item 304 can include a transparent and/or translucent portion and can be, but is not limited to being, a stock ticker, a weather forecast, an icon, an information providing applet, a traffic feed, a system utility, a camera viewer, a calendar, a clock, a game, a search tool, an application enhancer, a media player, a volume control, an audio clip player, a sound byte player, a monitor adjuster, etc. The enhancement component 302 provides the display of at least the graphical item 304 that includes areas of translucency, transparency, and/or any combination thereof.

Furthermore, the enhancement component 302 can utilize a data store (not shown), wherein the data store can store various data related to the system 300. The data store can provide storage for the graphical item 304, settings related to displaying the graphical item 304, historic data, profiles, usernames, display settings, transparency and/or translucency settings, and/or any data related to the system 300, etc. The data store can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store of the subject systems and methods is intended to comprise, without being limited to, these and any other suitable types of memory. In addition, it is to be appreciated that the data store can be a server, a database, a hard drive, and the like.

The enhancement component 302 can include an analyzer 306 that can dynamically separate data related to the graphical item 304 that is to be displayed into a first portion and a second portion. The analyzer 306 can determine the portions of the graphical item 304 that relate to the first portion, wherein the first portion includes opaque and transparent areas. The first portion can be referred to as a foreground image such that the visual area (e.g., window) can host the browser engine. Moreover, the analyzer 306 can determine the portions of the graphical item 304 that relate to the second portion, wherein the second portion includes translucent and transparent areas. The second portion can be referred to as a background visual area (e.g., window). It is to be appreciated that a window can be a visual area containing some kind of user interface, displaying the output of and allowing the input for one of a number of simultaneously running computer processes.

Based at least in part upon the analysis provided by the analyzer 306, a generator 308 can create images related to the graphical item 304 to properly display such data with transparent and/or translucent portions by leveraging the browser component 108. The generator 308 can create the image for the background visual area (e.g., the second portion) by setting at least one pixel with an alpha value equal to opaque (e.g., 255, any value relatively having opaque characteristics, etc.) to transparent (e.g., 0, any value relatively having transparent characteristics, etc.). The generator 308 can employ any suitable technique in order to create the image for the background visual area (e.g., background window) such that the pixels are filtered to have solely transparent or translucent pixels.

The generator 308 can create the foreground image (e.g., the first portion) by setting non-opaque pixels to opaque with a particular color. In other words, the generator 308 can set a pixel with an alpha value not equal to opaque (e.g., 255, any value relatively having opaque characteristics, etc.) to opaque (e.g., 255, any value relatively having opaque characteristics, etc.) and the particular color set to an obscure color (e.g., RBG value). The generator 308 can provide pixels that are fully opaque based at least in part upon creating the foreground image and the background visual area.

Furthermore, the foreground image can be hosted in the browser control associated with the browser component 108. Thus, post-processing can be implemented on the foreground image by, for example, a map component 310. The map component 310 can be associated with the enhancement component 302 to provide any suitable mapping technique and/or post-processing related to the browser control in order to display the first portion and the second portion, wherein the combination includes transparent and/or translucent portions for the graphical item 304. For example, the map component 310 can map pixels related to the dynamically separated portions with the obscure color (e.g., RBG value) to transparent. The obscure color can be, for example, any color that is not included within the graphical item 304, the gadget including the graphical item 304, etc.

It is to be appreciated that the foreground image and the background visual area can utilize a layered technology with a particular style. For instance, a 32 bit operating system that utilizes graphical user interfaces can include a layered technology and can be utilized with the claimed subject matter. Moreover, such 32 bit operating system can include a WS_EX_LAYERED style. For instance, the foreground window can utilize a SetLayeredWindowAttributes( ) function to map a single color to transparent. In addition, the background visual area can utilize an UpdateLayeredWindow( ) function to display its translucent image. It is to be appreciated and understood that the above functions can be related to the 32 bit operating system that utilizes graphical user interfaces.

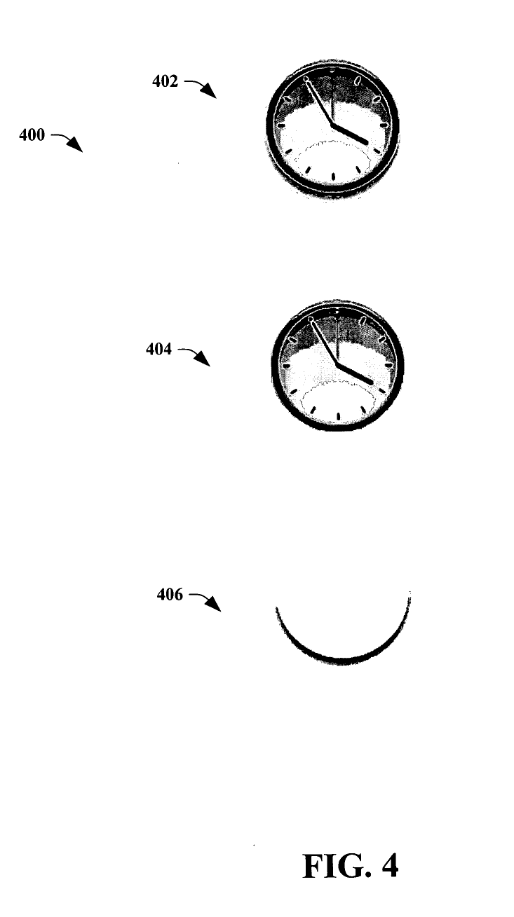

FIG. 4 illustrates a series 400 of portions related to a graphical item rendered by leveraging a browser. A gadget 402 can include the graphical item 402 that includes translucent and/or transparent portions and can be displayed by leveraging a browser rendering engine as described in pervious figures. In other words, the gadget 402 can include various graphical items, wherein the graphical items collectively can be referred to as gadgets. The gadgets can be suitable applet, image, application, small task items, and/or program, wherein such applet, image, application, small task item, and/or program. In particular, the gadget 402 can include various graphical items and has a drop shadow (e.g., translucent portion) and a non-rectangular shape (e.g., transparent portions creating a circular clock without any borders, captions, and/or chrome).

It is to be appreciated that the gadget 402 can include various graphical items, wherein each graphical item can include transparent and/or translucent portions. Furthermore, the gadget 402 can be associated with any suitable applet, image, application, small task items, and/or program, wherein such applet, image, application, small task item, and/or program. Although the gadget 402 is illustrated as a clock, the claimed subject matter is not so limited. For example, the gadget can include a transparent and/or translucent portion related to a graphical item and can be, but is not limited to being, a stock ticker, a weather forecast, an icon, an information providing applet, a traffic feed, a system utility, a camera viewer, a calendar, a digital clock, a game, a search tool, an application enhancer, a media player, a volume control, an audio clip player, a sound byte player, a monitor adjuster, etc. As described above, the gadget 402 can be displayed including any areas of translucency, transparency, and/or any combination thereof.

As discussed above, the graphical items to be displayed can be dynamically separated into a first portion and a second portion. A first portion 404 illustrates a foreground image which can be the visual area (e.g., window) that hosts the browser. The first portion 404 can include opaque and transparent areas and/or parts (e.g., transparent areas provide roundness of the clock, opaque areas provide the clock itself, etc.). A second portion 406 can be displayed in a background visual area (e.g., background window). The second portion 406 can include translucent and transparent areas and/or parts (e.g., translucent part provides shadowing, transparent part provides roundness of the clock, etc.). By combining the first portion 404 and the second portion 406, the gadget 402 can be displayed by leveraging the browser, wherein the gadget can include various graphical items that contain transparent and/or translucent portions.

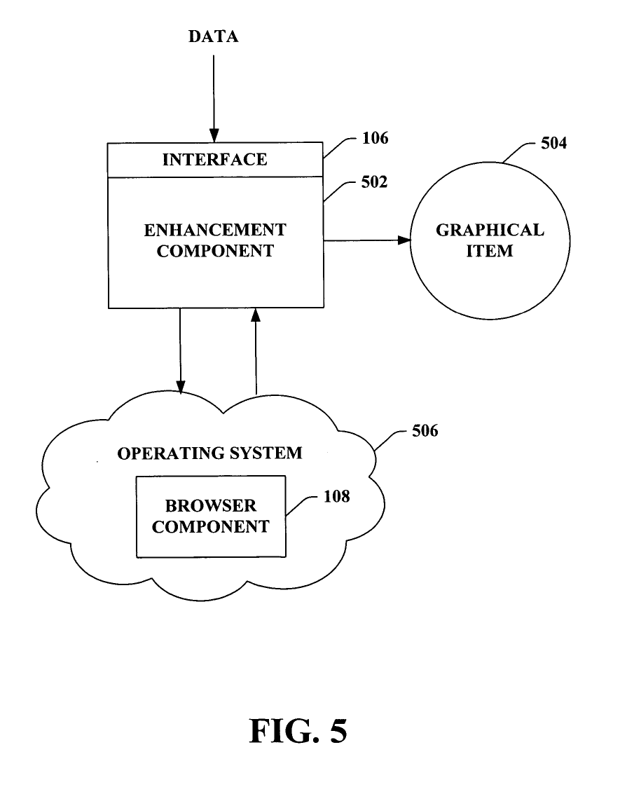

FIG. 5 illustrates a system 500 that facilitates employing a graphical item by leveraging a browser associated with an operating system to provide translucent and/or transparent portion of the graphical item. The system 500 can include an enhancement component 502 that provides display of a graphical item 504, wherein the graphical item 504 can include a transparent portion and/or a translucent portion, and/or any combination thereof. The graphical item 504 can be associated with a gadget such that the gadget can be any suitable applet, image, application, small task items, and/or program. The enhancement component 502 can display the transparent and/or translucent portions associated with the graphical item 504 with the leveraging of the browser component 108. The browser component 108 can include, for instance, a rendering engine that can be implemented to display the graphical item 504.

For example, various graphical items can be collectively associated with a stock ticker applet which dynamically displays stock quotes. Typically, a portion to be displayed that relates to the stock ticker applet can be constricted by a rectangular visual area with solely opaque portions. The stock ticker applet can occlude, conceal, and/or obstruct a wallpaper and/or background associated with a typical operating system and minimize the amount of data presented on the display. By implementing the system 500, the stock ticker applet can be displayed with translucent and/or transparent portions such that the applet is not restricted to have a rectangular visual area and solely opaque portions (e.g., a border, a caption, a chrome, etc.).

It is to be appreciated that the graphical item 504 can be associated with any suitable applet, image, application, small task items, and/or program and the above example is not to be limiting on the claimed subject matter. In addition, the applet, image, application, small task item, and/or program can be referred to as a “gadget.” For example, gadget can be, but is not limited to being, a stock ticker, a weather forecast, an icon, an information providing applet, a traffic feed, a system utility, a camera viewer, a calendar, a clock, a game, a search tool, an application enhancer, a media player, a volume control, an audio clip player, a sound byte player, a monitor adjuster, etc.

An operating system 506 can host the browser component 108 to allow the rendering and/or display of the graphical item 504 that contains at least one of a transparent portion and a translucent portion. The operating system 506 can be any suitable operating system that utilizes a graphical user interface. Furthermore, the operating system 506 can utilize the browser component 108 in conjunction with a layered windows technology having a WS_EX_LAYERED style. It is to be appreciated that the term windows can refer to a visual area containing some kind of user interface, displaying the output of and allowing input for one of a number of simultaneously running computer processes and it is not to be limiting on the subject invention. The browser component 108 can be hosted by the operating system 506, wherein the enhancement component 502 can leverage such browser component 108 to display the graphical item 504. Moreover, although the operating system 506 and the enhancement component 502 are illustrated as separate components, it is to be appreciated that the enhancement component 502 can be incorporated into the operating system 506, a stand-alone unit, and/or any combination thereof.

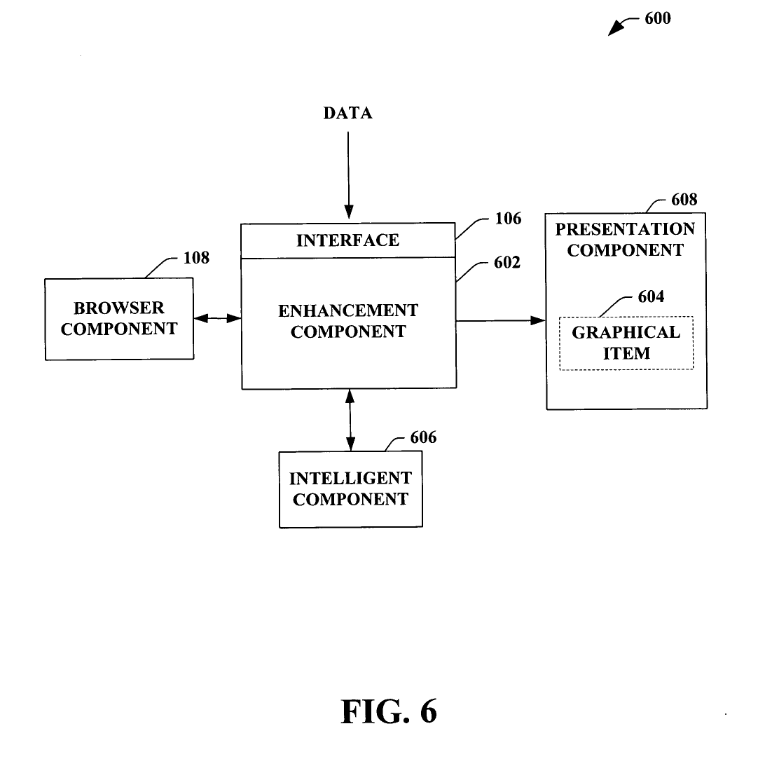

FIG. 6 illustrates a system 600 that employs intelligence to facilitate displaying a graphical item having at least one of a transparent and translucent portion by leveraging a browser engine. The system 600 can include an enhancement component 602, a graphical item 604, and the browser component 108 that can all be substantially similar to respective components, and items, described in previous figures. The system 600 further includes an intelligent component 606. The intelligent component 606 can be utilized by the enhancement component 602 to facilitate displaying the graphical item 604, wherein the graphical item can include a transparent portion and/or a translucent portion. For example, the intelligent component 606 can infer display settings, configurations related to generating a background visual area and foreground image, alpha settings, alpha limits (e.g., upper and lower), browser rendering engine implementation, dynamic partitioning of the graphical item, etc.

It is to be understood that the intelligent component 606 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

A presentation component 608 can be associated with the graphical item 604 that has at least one of a transparent and translucent portion. The presentation component 608 can provide various types of user interfaces to facilitate interaction between at least one user. The presentation component 608 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components associated with the enhancement component 602, wherein the interaction can include the display of the graphical item 604.

The user can also interact with the regions to select and provide information via various devices such as a mouse, a roller ball, a keypad, a keyboard, a pen and/or voice activation, for example. Typically, a mechanism such as a push button or the enter key on the keyboard can be employed. However, it is to be appreciated that the claimed subject matter is not so limited. For example, merely highlighting a check box can initiate information conveyance. In another example, a command line interface can be employed that further utilizes the graphical item 604. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

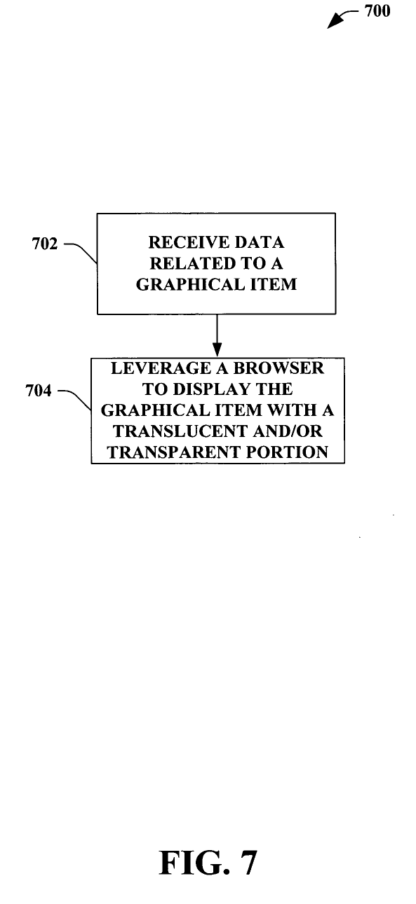

FIGS. 7-9 illustrate methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a methodology 700 for creating and/or presenting a graphical item including two portions utilizing a browser rendering engine. At reference numeral 702, data related to a graphical item can be received. The graphical item can include a transparent portion and/or a translucent portion. For example, the data can be any suitable applet, image, application, small task items, and/or program, wherein such applet, image, application, small task item, and/or program can be referred to as a “gadget.” For example, the graphical item can include a transparent and/or translucent portion and can be, but is not limited to being, a stock ticker, a weather forecast, an icon, an information providing applet, a traffic feed, a system utility, a camera viewer, a calendar, a clock, a game, a search tool, an application enhancer, a media player, a volume control, an audio clip player, a sound byte player, a monitor adjuster, etc. Thus, a plurality of graphical items can collectively represent the gadget.

At reference numeral 704, a browser can be leveraged to display the graphical item with a transparent portion and/or a translucent portion. In particular, the rendering engine associated with a browser can facilitate displaying the graphical item and/or collective graphical items (e.g., gadgets), wherein such graphical items can include transparent and/or translucent areas, portions, and/or parts. Moreover, the graphical items can be displayed on any suitable display device associated with an operating system that utilizes a graphical user interface.

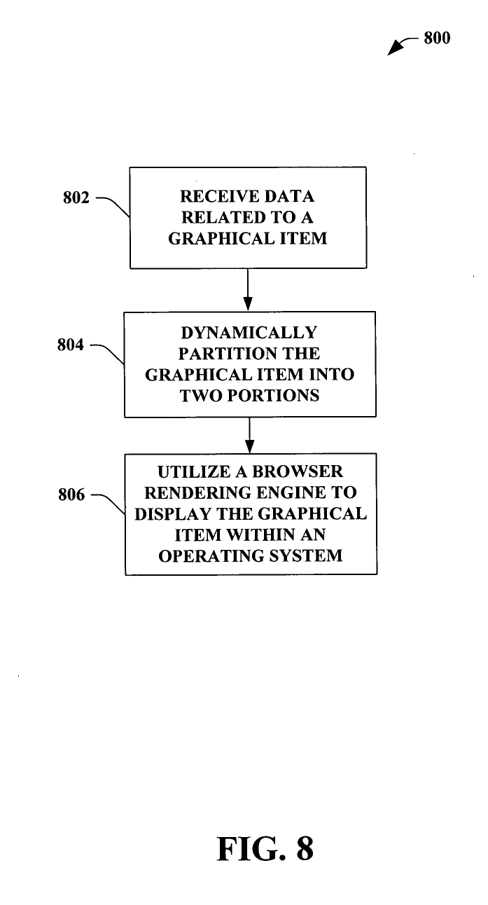

FIG. 8 illustrates a methodology 800 that facilitates employing a graphical item referred to as a gadget that has a transparent and/or translucent portion by leveraging a rendering engine related to a browser. At reference numeral 802, data related to a graphical item can be received. At reference numeral 804, the graphical item can be dynamically partitioned into a first portion and a second portion. The first portion illustrates a foreground image which can be the visual area (e.g., window) that hosts the browser. The first portion can include opaque and transparent areas and/or parts. The second portion can be displayed in a background visual area (e.g., background window). The second portion can include translucent and transparent areas and/or parts.

At reference numeral 806, a browser rendering engine can be utilized to display at least one of the graphical item, first portion, and the second portion within an operating system. By combining the first portion and the second portion, the translucent and/or transparent portions can be displayed by leveraging the browser engine. Moreover, upon combining the first portion and the second portion, various post-processing can be implemented upon the graphical item such as, but not limited to, mapping pixels.

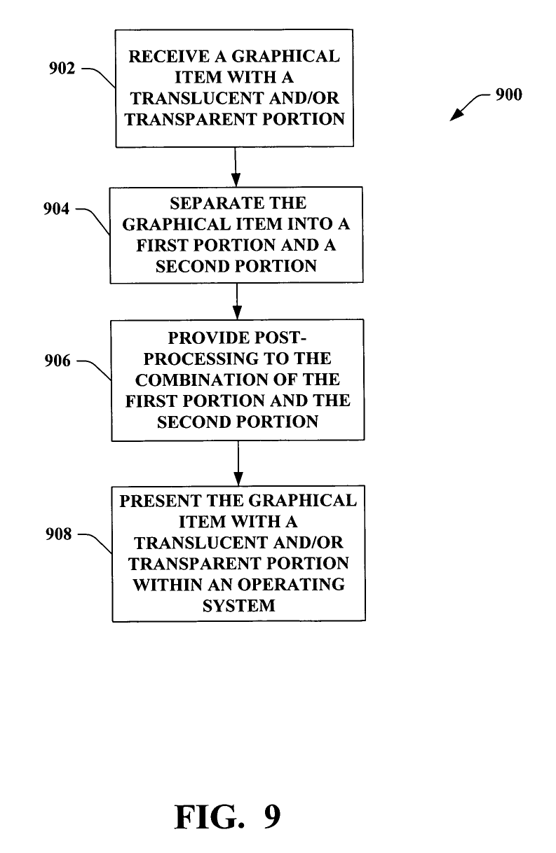

FIG. 9 illustrates a methodology 900 that facilitates displaying a graphical item having at least one of a transparent and translucent portion by leveraging a browser engine. At reference numeral 902, a graphical item with a translucent and/or transparent area, part, and/or portion can be received. At reference numeral 904, the graphical item can be separated into a first portion and a second portion. It is to be appreciated that the graphical item can be associated with a gadget, wherein the gadget can be at least one of any suitable applet, image, application, small task items, and/or program.

The first portion can include opaque and transparent areas. The first portion can be referred to as a foreground image such that the visual area (e.g., window) can host the browser engine. The second portion can include translucent and transparent areas. The second portion can be referred to as a background visual area (e.g., window). It is to be appreciated that a window can be a visual area containing some kind of user interface, displaying the output of and allowing the input for one of a number of simultaneously running computer processes. The image for the background visual area (e.g., the second portion) can be created by setting at least one pixel with an alpha value equal to opaque (e.g., 255, any value relatively having opaque characteristics, etc.) to transparent (e.g., 0, any value relatively having transparent characteristics, etc.). The foreground image (e.g., the first portion) can be created by setting non-opaque pixels to opaque with a particular color. In other words, a pixel can be set with an alpha value not equal to opaque (e.g., 255, any value relatively having opaque characteristics, etc.) to opaque (e.g., 255, any value relatively having opaque characteristics, etc.) and the particular color set to an obscure color (e.g., RBG value).

At reference numeral 906, post-processing to the graphical item (e.g., the combination of the first portion and the second portion) can be provided. For example, the post-processing can include, but is not limited to, mapping. It is to be appreciated that any suitable mapping technique and/or post-processing related to the browser control in order to display the first portion and the second portion can be implemented, wherein the combination includes transparent and/or translucent portions for the graphical item. For example, pixels related to the dynamically separated portions can be mapped with the obscure color (e.g., RBG value) to transparent. The obscure color can be, for example, any color that is not included within the graphical item, the gadget including the graphical item, etc. At reference numeral 908, the graphical item with a translucent and/or transparent portion can be presented to, for instance, a user, via a display device associated with an operating system.

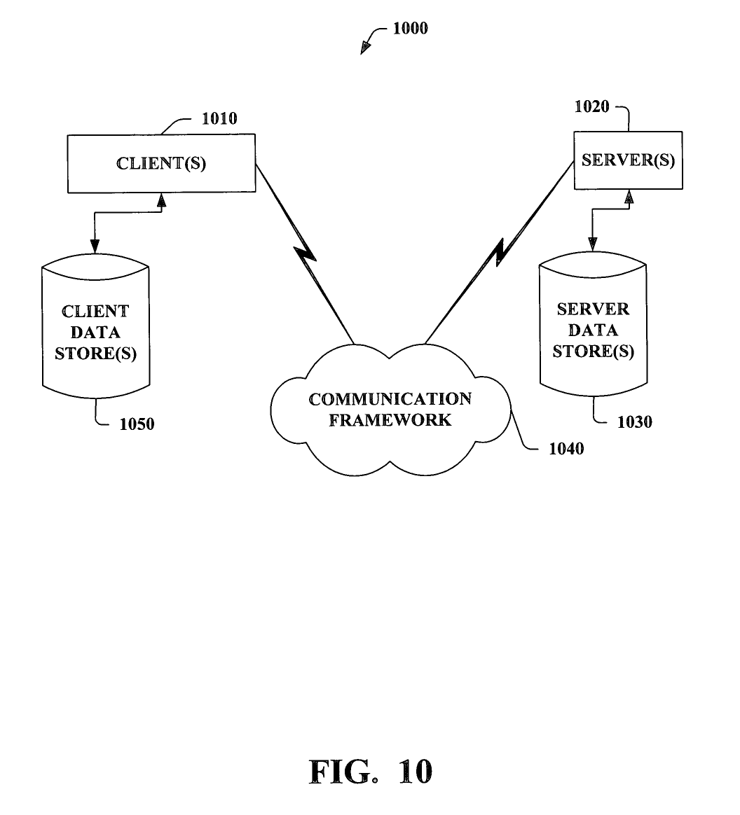

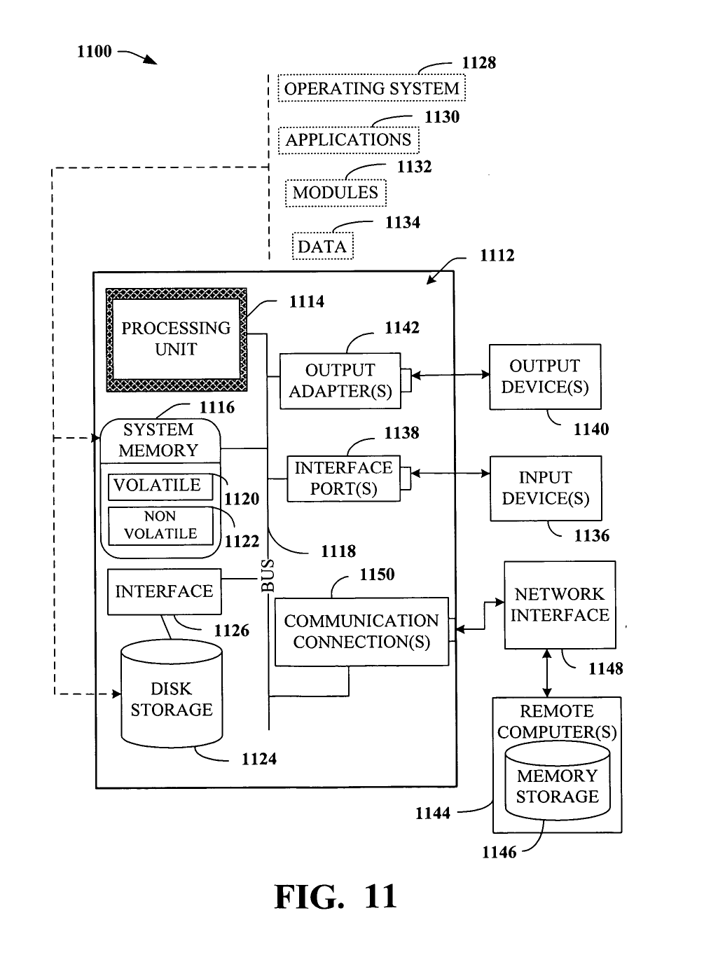

In order to provide additional context for implementing various aspects of the claimed subject matter, FIGS. 10-11 and the following discussion is intended to provide a brief, general description of a suitable computing environment in which the various aspects of the subject innovation may be implemented. For example, an enhancement component that leverages a browser rendering engine to display a graphical item having a transparent and/or translucent portion, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 10 is a schematic block diagram of a sample-computing environment 1000 with which the claimed subject matter can interact. The system 1000 includes one or more client(s) 1010. The client(s) 1010 can be hardware and/or software (e.g., threads, processes, computing devices). The system 1000 also includes one or more server(s) 1020. The server(s) 1020 can be hardware and/or software (e.g., threads, processes, computing devices). The servers 1020 can house threads to perform transformations by employing the subject innovation, for example.

One possible communication between a client 1010 and a server 1020 can be in the form of a data packet adapted to be transmitted between two or more computer processes. The system 1000 includes a communication framework 1040 that can be employed to facilitate communications between the client(s) 1010 and the server(s) 1020. The client(s) 1010 are operably connected to one or more client data store(s) 1050 that can be employed to store information local to the client(s) 1010. Similarly, the server(s) 1020 are operably connected to one or more server data store(s) 1030 that can be employed to store information local to the servers 1020.

With reference to FIG. 11, an exemplary environment 1100 for implementing various aspects of the claimed subject matter includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), or flash memory. Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also includes removable/non-removable, volatile/non-volatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in the suitable operating environment 1100. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the claimed subject matter can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates displaying a graphical item, comprising:
an interface component that facilitates receipt of data associated with the graphical item associated with an operating system; and
an enhancement component that leverages a browser to display the graphical item with at least one of a translucent portion and a transparent portion.

2. The system of claim 1, the graphical item includes at an opaque portion.

3. The system of claim 1, the graphical item is associated with a gadget that is at least one of the following: an applet; an image; an application; a small task item; and a program.

4. The system of claim 3, the gadget is at least one of the following: a stock ticker; a weather forecast; an icon; an information providing applet; a traffic feed; a system utility; a camera viewer; a calendar; a clock; a game; a search tool; an application enhancer; a media player; a volume control; an audio clip player; a sound byte player; and a monitor adjuster.

5. The system of claim 1, the graphical item is displayed with the translucent portion and the transparent portion.

6. The system of claim 1, the enhancement component leverages a browser rendering engine to display the graphical item.

7. The system of claim 1, further comprising a display device that displays the graphical item to a user.

8. The system of claim 7, the display device is at least one of a monitor, a liquid crystal display (LCD), a flat-panel, a computer monitor, a television, a plasma screen, a touch-screen, and a portable digital assistant (PDA).

9. The system of claim 1, further comprising an analyzer component that dynamically separates at least one pixel associated with the graphical item into a first portion and a second portion, the first portion is a foreground image that is hosted by the browser and the second portion is a background visual area.

10. The system of claim 9, the first portion includes solely opaque and transparent pixels.

11. The system of claim 9, the second portion includes solely translucent and transparent pixels.

12. The system of claim 9, further comprising a generator that creates the first portion by setting a non-opaque pixel to opaque with a particular color.

13. The system of claim 9, the generator creates the second portion by setting a pixel with an alpha value equal to an alpha value related with opaqueness to an alpha value associated with being transparent.

14. The system of claim 12, further comprising a map component that implements post-processing on the first portion by mapping the pixels with the particular color to be transparent.

15. The system of claim 14, the particular color is not within the graphical item.

16. The system of claim 9, further comprising a layered window technology with a WS_EX_LAYERED style, wherein a SetLayeredWindowAttributes( ) function is utilized with the foreground image to map the particular color to transparent and an UpdateLayeredWindow( ) function is utilized by the background visual area to display the translucent pixel.

17. A machine implemented method that facilitates presenting a graphical item to a display, comprising:
receiving data related to a graphical item; and
leveraging a browser rendering engine to display the graphical item with at least one of translucent portion and a transparent portion.

18. The method of claim 17, further comprising:
dynamically partitioning the graphical item to a first portion and a second portion; and
displaying the graphical item to a user.

19. The method of claim 17, further comprising providing post-processing to the combination of the first portion and the second portion.

20. A machine implemented system that facilitates displaying a graphical item comprising:
means for receiving data associated with the graphical item associated with an operating system; and
means for leveraging a browser to display the graphical item with at least one of a translucent portion and a transparent portion.
